(19) United States
(12) Patent Application Publication
(10) Pub. No.: US 2024/0112334 A1
(43) Pub. Date: Apr. 4, 2024

(54) COMPUTER-IMPLEMENTED METHOD FOR PROVIDING A POSITIONING SCORE REGARDING A POSITIONING OF AN EXAMINING REGION IN AN X-RAY IMAGE

(71) Applicant: Siemens Healthcare GmbH, Erlangen (DE)

(72) Inventors: Manasi DATAR, Erfurt (DE); Ramyar BINIAZAN, Nuernberg (DE); Peter ZERFASS, Fuerth (DE)

(73) Assignee: Siemens Healthcare GmbH, Erlangen (DE)

(21) Appl. No.: 18/476,533

(22) Filed: Sep. 28, 2023

(30) Foreign Application Priority Data
Sep. 29, 2022 (EP) 22198725.8

(51) Int. Cl. G06T 7/00; G06T 3/60; G06T 7/11; G06T 7/73; G06V 10/77

(52) U.S. Cl. CPC G06T 7/0012; G06T 3/60; G06T 7/11; G06T 7/73; G06V 10/7715; G06T 2207/10116; G06T 2207/20081; G06T 2207/20084; G06T 2207/30068

(57) ABSTRACT

One or more example embodiments of the present invention relates to Computer-implemented method for providing a positioning score regarding a positioning of an examining region in an X-ray image, comprising receiving input data, the input data comprising an X-ray image including the examining region; applying a first trained function to the input data to detect at least one region of interest in the X-ray image and to generate a heatmap comprising the at least one region of interest; applying a second trained function to the input data and the heatmap to generate an individual score for each of the at least one region of interest and to generate a score-weighted heatmap based on the at least one region of interest and the individual scores; applying a third trained function to the input data and the score-weighted heatmap to generate a positioning score; and providing the positioning score.

### CROSS-REFERENCE TO RELATED APPLICATION(S)

The present application claims priority under 35 U.S.C. § 119 to European Patent Application No. 22198725.8, filed Sep. 29, 2022, the entire contents of which are incorporated herein by reference.

### FIELD

One or more example embodiments of the present invention relates to computer-implemented method for providing a positioning score regarding a positioning of an examining region in an X-ray image, wherein the computer-implemented method allows the user to understand and follow the steps towards the determination of the positioning score. One or more example embodiments of the present invention further relates to a scoring system, a computer-readable medium, a computer program product and an X-ray system, each with corresponding features to the computer-implemented method.

### RELATED ART

An X-ray system, e.g. a radiography system or a fluoroscopy system, comprises an X-ray source and an X-ray detector. The examination object, in particular a patient, is arranged between the X-ray source and the X-ray detector so that an X-ray image of an examination region can be acquired.

A mammography system includes an X-ray source and an X-ray detector, with a breast arranged between the X-ray source and the X-ray detector. The examination area comprises the breast, especially the entire breast. In general, the breast is compressed or fixed via a compression unit. For this purpose, in particular, the surface of the X-ray detector or a housing of the X-ray detector and an essentially parallel arranged compression plate can be used. Furthermore, other forms of the compression unit are known. An X-ray data set can be generated. The X-ray data set may include a digital full-field mammography image and/or a tomosynthesis image.

Modern mammography systems offer a tomosynthesis function to generate a series of projections that allow a three-dimensional representation of the breast using reconstructed layers. Here, the X-ray emitter or the X-ray source moves in an angular range of 15 to 50 degrees over the compressed breast. The digital full-field mammography image and the tomosynthesis image can also be acquired together within a single compression (per breast).

One of the major problems in radiological (x-ray) examinations is the high rate of rejected images due to poor image quality. According to one study by B. Hofmann et al, Image rejects in general direct radiography, (Norway), 51.3% of images are rejected due to positioning errors. A rejected image does not contribute to diagnostics, and therefore is a useless image which causes additional exposure of patients to obtain a correctly positioned image. For this reason, it is important to have a technique to improve acquisition accuracy for x-ray exams through quality analysis and feedback about position accuracy.

Among radiographic images, knee images have the highest relative rate of being rejected/deleted (e.g. 20.1% according to Hofmann) with the most prevalent reason being ‘positioning of patient or system’. Many images are rejected despite being adequate for medical decisions.

There are several solutions and techniques to address positioning problems for x-ray images. In general, most of the current solutions can be categorized in one of the two following approaches:

The first approach relies on segmentation of different organs and landmarks in the x-ray image and by having those landmarks, one can define some general rules based on measurements to evaluate different positioning criteria. Such solutions are heavily dependent on the accuracy of landmark detection and segmentation models, and only a few millimeters error can lead to wrong positioning evaluation. Within a knee segmentation a small error of fibular head segmentation can lead to two different positioning evaluations.

The second approach does not require segmentation masks and can evaluate different positioning criteria by only having the input image. In this approach, different models for different criteria have been trained to categorize input image, let us consider the previous example for fibular head overlap in knee images. A model should be trained in a way to evaluate rotation of knee based on this criterion by observing huge dataset. Still, the problem remains that the user can not follow and/or influence the determination of the positioning analysis.

Current AI based solutions use black-box models and provide results that are difficult to interpret or explain, leading to concerns regarding their trustworthiness and reliability. This hampers the widespread acceptance of AI based solutions in applications such as image positioning. There have been efforts to interpret or explain the AI model decision-making process using feature/saliency maps to indicate the importance of various image regions toward the model output. These saliency maps typically back-propagate gradients and project them onto the image plane, allowing the user to visualize an approximation of the underlying process followed by the AI model. Saliency maps attempt to improve AI interpretability but do not address AI transparency and explainability in a comprehensive manner.

### SUMMARY

One or more example embodiments of the present invention provides a computer-implemented method for providing a positioning score regarding a positioning of an examining region in an X-ray image, a scoring system, a computer program product, a computer-readable medium, and an X-ray system, which allows the user to understand and follow the steps towards the determination of the positioning score.

One or more example embodiments of the present invention provides a computer-implemented method for providing a positioning score regarding a positioning of an examining region in an X-ray image according to claim 1, a scoring system according to claim 10, a computer program product according to claim 11, a computer-readable medium according to claim 12, and an X-ray system according to claim 13.

In the following the solution according to one or more example embodiments of the present invention is described with respect to the claimed scoring systems as well as with respect to the claimed methods. Features, advantages or alternative embodiments herein can be assigned to the other claimed objects and vice versa. In other words, claims for the scoring systems can be improved with features described or claimed in the context of the methods. In this case, the functional features of the method are embodied by objective units of the scoring system.

Furthermore, in the following the solution according to one or more example embodiments of the present invention is described with respect to methods and systems for providing a positioning score regarding a positioning of an examining region in an X-ray image as well as with respect to methods and systems for the training of the trained functions. Features, advantages or alternative embodiments herein can be assigned to the other claimed objects and vice versa. In other words, claims for methods and systems for training of the trained function can be improved with features described or claimed in context of the methods and systems for providing a positioning score regarding a positioning of an examining region in an X-ray image, and vice versa.

In particular, the trained function of the methods and systems for providing complete set of second key elements in an X-ray image can be adapted by the methods and systems for training of the trained function. Furthermore, the input data can comprise advantageous features and embodiments of the training input data, and vice versa. Furthermore, the output data can comprise advantageous features and embodiments of the output training data, and vice versa.

The inventors found that especially for knee examinations, the positioning is crucial. As a reason, this invention would focus more on knee x-ray images as a major application for proposed solution. It is noteworthy to mention that the proposed solution can be extended for use in all x-ray examinations.

### BRIEF DESCRIPTION OF THE DRAWINGS

Examples embodiments of the invention are explained in more detail below by means of drawings.

FIG. 1 a schematic representation of the method for providing a positioning score regarding a positioning of an examining region in an X-ray image according to one or more example embodiments;

FIG. 2 a schematic representation of the application of a second trained function according to one or more example embodiments;

FIG. 3 a schematic representation of the application of a third trained function according to one or more example embodiments;

FIG. 4 a schematic representation of a neural network according to one or more example embodiments of the invention; and

FIG. 5 a schematic representation of a convolutional neural network according to one or more example embodiments of the invention.

FIG. 6 a schematic representation of a mammography system according to one or more example embodiments; and

FIG. 7 a schematic representation of an X-ray system according to one or more example embodiments.

### DETAILED DESCRIPTION

One or more example embodiments of the present invention relates to a computer-implemented method for providing a positioning score regarding a positioning of an examining region in an X-ray image, comprising:
Receiving input data, in particular with a first interface, wherein the input data comprises an X-ray image comprising the examining region,
Applying a first trained function to the input data, in particular with a first computation unit, wherein at least one region of interest is detected in the X-ray image and a heatmap comprising the at least one region of interest is generated,
Applying a second trained function to the input data, in particular with a second computation unit, and the heatmap, wherein an individual score for each of the at least one region of interest is generated, and a score-weighted heatmap is generated based on the at least one region of interest and the individual scores,
Applying a third trained function to the input data, in particular with a third computation unit, and the score-weighted heatmap, wherein a positioning score is generated, Providing the positioning score, in particular with a second interface.

According to an aspect of one or more example embodiments of the present invention, the X-ray image is a two-dimensional X-ray image.

According to an aspect of one or more example embodiments of the present invention, the first trained function is based on an object detection network, preferably the RetinaNet.

According to an aspect of one or more example embodiments of the present invention, the second trained function and/or the third trained function is based on a classifier, preferably the Densenet, or a regression model.

According to an aspect of one or more example embodiments of the present invention, the initial convolution layer is modified to focus the network attention based on the heatmap and/or the score-weighted heatmap.

According to an aspect of one or more example embodiments of the present invention, the heatmap and/or the at least one region of interest is displayed.

According to an aspect of one or more example embodiments of the present invention, the user can adjust the heatmap and/or the at least one region of interest.

According to an aspect of one or more example embodiments of the present invention, the position scored describes a rotation of the examining region.

According to an aspect of one or more example embodiments of the present invention, Method according one of the preceding claims, wherein the examining region comprises a knee, the thorax, or a breast.

One or more example embodiments of the present invention further relates to a scoring system, comprising:
a first interface, configured for receiving input data, wherein the input data comprises an X-ray image comprising the examining region,
a first computation unit, configured for applying a first trained function to the first input data, wherein first output data is generated, wherein at least one region of interest is detected in the X-ray image and a heatmap comprising the at least one region of interest is generated,
a second computation unit, configured for applying a second trained function to the input data and the heatmap, wherein an individual score for each of the at least one region of interest is generated, and a score-weighted heatmap is generated based on the at least one region of interest and the individual scores,
a third computation unit, configured for applying a third trained function to the input data and the score-weighted heatmap, wherein a positioning score is generated,
a second interface, configured for providing the positioning score.

One or more example embodiments of the present invention further relates to a computer program product comprising instructions which, when the program is executed by a scoring system, cause the scoring system to carry out the method according to one or more example embodiments of the present invention.

One or more example embodiments of the present invention further relates to a computer-readable medium comprising instructions which, when executed by a scoring system, cause the scoring system to carry out the method according to one or more example embodiments of the present invention.

One or more example embodiments of the present invention further relates to an X-ray system comprising the scoring system according to one or more example embodiments of the present invention.

According to an aspect of one or more example embodiments of the present invention, the X-ray system is a radiography system or a mammography system.

A computer-implemented method for providing a third trained function, comprising:
receiving input training data, wherein the input training data comprises an X-ray image corresponding,
receiving output training data, wherein the output training data is related to the input training data, wherein the output training data comprises a positioning score,
training a first function, a second function and a third function based on the input training data and the output training data,
providing the first trained function, a second trained function and a third trained function.

A training system, comprising
a first training interface, configured for receiving input training data, wherein the input training data comprises an X-ray image,
a second training interface, configured for receiving output training data, wherein the output training data is related to the input training data, wherein the output training data comprises a positioning score,
a training computation unit, configured for training a first function, a second function and a third function based on the input training data and the output training data,
a third training interface, configured for providing the first trained function, a second trained function and a third trained function.

In general, parameters of a trained function can be adapted via training. In particular, supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Q-learning, genetic algorithms and/or association rules. In particular, a neural network can be a deep neural network, a convolutional neural network or a convolutional deep neural network. Furthermore, a neural network can be an adversarial network, a deep adversarial network and/or a generative adversarial network.

The idea behind this invention is to build a transparent, interpretable and explainable AI model for positioning check in radiological images or X-ray images in general. In the current manual workflow, an expert user performs the following steps:
Identify various regions of interest (ROI) based on the anatomy being scanned.
Score the identified ROI based on their quality.
Score the overall positioning within the image based on the ROIs and scores from previous steps.

This invention formulates an analogous AI-based workflow with explicit sub-tasks corresponding to each of the steps in the manual workflow.

A modular pipeline for AI-based positioning check is proposed. A radiographic image or an X-ray image is used as input. The expected output is the overall score indicating the quality of positioning for the given image. The AI-based sub-tasks are encapsulated by three modules:
ROI detector for object detection as a first trained function;
Bank of ROI scoring modules for classification or regression as a bank of second trained functions,
Overall scoring module for classification or regression as a third trained function.

The first trained function which can be called the ROI Detector uses radiographic image or an X-ray image as input, and provides relevant ROIs in the image as output. The first trained function or the ROI detector detects and identifies all relevant ROIs present in the image. This module can be realized using an available object detection network such as the RetinaNet.

The bank of second trained functions which can be called a bank of ROI scoring modules uses a radiographic image or an X-ray image as well as a ROI heatmap as input and provides individual ROI scores as output.

The second trained functions or the ROI scoring modules score each available ROI by focusing attention on the corresponding image region underlying the ROI. This is achieved by using an additional input based on a heatmap representation of the ROI. An ROI scoring module can be realized using an available classifier architecture such as the Densenet and modifying the initial convolution layer to focus the network attention based on the ROI heatmap. The classifier architecture can be replaced with a regression model to increase the scoring sensitivity from a categorical to a continuous range.

The third trained function can be called the overall scoring module. The third trained function uses a radiographic image or an X-ray image as well as a score-weighted ROI heatmap as input and provides the final positioning score as output.

The overall scoring module computes the final positioning score for the input radiographic image by focusing attention on the image region underlying all available ROIs and their corresponding scores. This is achieved by using an additional input based on an aggregated score-weighted heatmap representation of all available ROIs. An overall scoring module can be realized using an available classifier architecture such as the Densenet and modifying the initial convolution layer to focus the network attention based on the aggregated, score-weighted heatmap. The classifier architecture can be replaced with a regression model to increase the scoring sensitivity from a categorical to a continuous range.

To explain the idea behind one or more example embodiments of the present invention, three applications have been chosen, to show how proposed method can be used to assess positioning criteria.

As it was mentioned before, knee positioning check is the main application for proposed method. Two of the most important criteria in knee x-ray images is the position of Fibular head and the location of Patellar center. Both landmarks are used to evaluate rotation in knee images. For first criteria, the amount of overlap between Fibular head and Tibia could indicate rotation. In this case, when the amount of overlap is less than or more than a certain range (e.g. 25% of Fibular width) this could indicate internal or external rotation respectively. In second criteria, location of Patellar is compared to center of Femur. In case of not being exactly in the center, one can assume that there is a possibility of rotation. Our proposed method can be used in this application by first detecting the region of interests by the ROI detector and then categorizing those ROIs (ROI scoring) and finally judge the overall rotation of knee by having all previous results (Overall scoring).

Another application could be evaluating the rotation of chest x-ray images. Here, position of vertebra column and Clavicles are compared to each other to estimate rotation. By having the ROI of this specific region and categorizing it, one can define rotation of whole image.

Another application is related to positioning check of mammography images. In this case, location of nipple and the inframammary fold (IMF) shape is important to evaluate the position of breast. Again, one can evaluate these positioning criteria by defining ROIs and respective scores to them.

The proposed method provides insights into the decision-making process by deconstructing the task into its component steps and providing corresponding intermediate outputs as explanations. The component steps are designed based on the workflow of an expert user and provide transparency, interpretability and explicit explainability to our AI model's decision-making process.

The proposed method additionally allows for expert intervention or feedback at any step of the AI model's decision-making process by allowing the expert user to change the ROI (region of interest) definition at any step and/or attach increased/decreased importance to certain ROIs based on application-specific criteria.

The feedback in the form of modified ROI definition and/or scores can be used to retrain the corresponding models in the pipeline in an incremental (online) manner leading to improved accuracy across all intermediate steps for new/unseen cases.

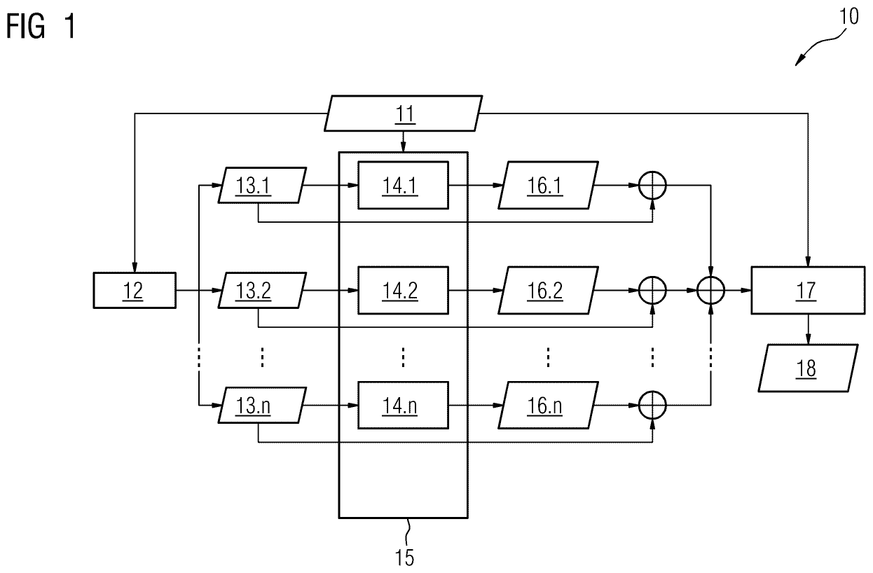

FIG. 1 displays an embodiment of the method 10 for providing a positioning score regarding a positioning of an examining region in an X-ray image according to the invention. The computer-implemented method 10 for providing a positioning score regarding a positioning of an examining region in an X-ray image, comprises the steps, preferably in the following order:
Receiving input data wherein the input data comprises an X-ray image 11 comprising the examining region,
Applying a first trained function 12 to the input data, wherein at least one region of interest 13.1, 13.2, . . . , 13.n is detected in the X-ray image and a heatmap comprising the at least one region of interest is generated,
Applying a second trained function 14.1, 14.2, . . . , 14.n to the input data and the heatmap, wherein an individual score for each of the at least one region of interest is generated, and a score-weighted heatmap is generated based on the at least one region of interest and the individual scores 16.1, 16.2, . . . , 16.n,
Applying a third trained function 17 to the input data and the score-weighted heatmap, wherein a positioning score is generated,
Providing the positioning score 18.

The X-ray image 11 is a two-dimensional X-ray image. The first trained function 12 is based on an object detection network, preferably the RetinaNet. The second trained function 14.1, 14.2, . . . , 14.n and/or the third trained function 17 is based on a classifier, preferably the Densenet, or a regression model. The initial convolution layer is modified to focus the network attention based on the heatmap and/or the score-weighted heatmap. The heatmap and/or the at least one region of interest 13.1, 13.2, . . . , 13.n is displayed. The user can adjust the heatmap 19 and/or the at least one region of interest 13.1, 13.2, . . . , 13.n. A plurality of second trained functions 14.1, 14.2, . . . , 14.n can be described as bank of second trained functions 15. The positioning score 18 describes a rotation of the examining region. The examining region comprises a knee, the thorax, or a breast.

A modular pipeline for AI-based positioning check is proposed. A radiographic image or an X-ray image 11 is used as input. The expected output is the overall score, in particular the positioning score 18, indicating the quality of positioning for the given X-ray image 11. The AI-based sub-tasks are encapsulated by three modules:
ROI detector for object detection as a first trained function 12;
Bank of ROI scoring modules for classification or regression as a bank of second trained functions 15,
Overall scoring module for classification or regression as a third trained function 17.

The first trained function 12 which can be called the ROI Detector uses radiographic image or an X-ray image 11 as input, and provides relevant ROIs 13.1, 13.2, . . . , 13.n in the X-ray image 11 as output. The first trained function 12 or the ROI detector detects and identifies all relevant ROIs 13.1, 13.2, . . . , 13.n present in the X-ray image 11. This module can be realized using an available object detection network such as the RetinaNet.

The bank of second trained functions 15 which can be called a bank of ROI scoring modules uses a radiographic image or an X-ray image 11 as well as a ROI heatmap as input and provides individual ROI scores as output.

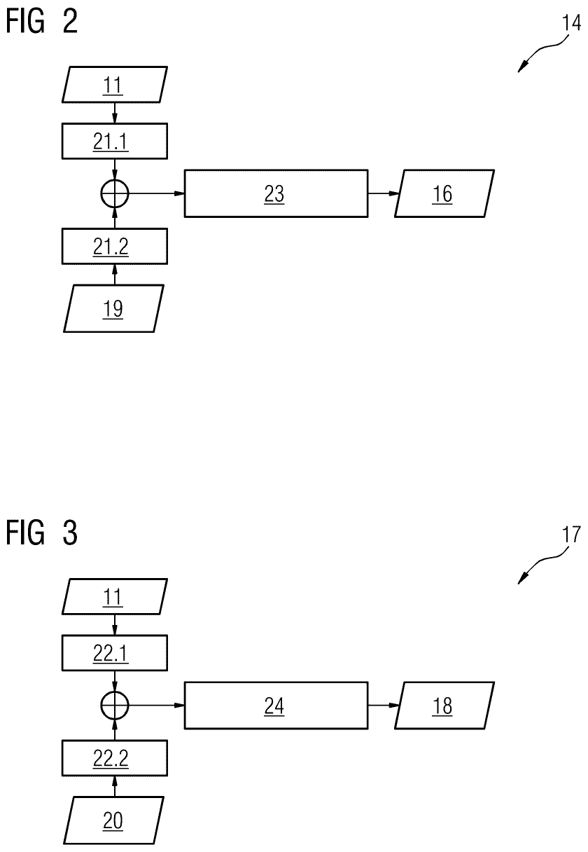

FIG. 2 displays an embodiment of the second trained function 14. The second trained functions 14 or the ROI scoring modules score each available ROI by focusing attention on the corresponding image region underlying the ROI. This is achieved by using an additional input based on a heatmap 19 representation of the ROI. An ROI scoring module can be realized using an available classifier architecture such as the Densenet 23 and modifying the initial convolution layer 21.1, 21.2 to focus the network attention based on the ROI heatmap. The classifier architecture can be replaced with a regression model to increase the scoring sensitivity from a categorical to a continuous range. An individual score 16 is provided as output.

FIG. 3 displays an embodiment of the third trained function 17. The third trained function 17 can be called the overall scoring module. The third trained function 17 uses a radiographic image or an X-ray image 11 as well as a score-weighted ROI heatmap 20 as input and provides the final positioning score 18 as output.

The overall scoring module computes the final positioning score for the input radiographic image by focusing attention on the image region underlying all available ROIs and their corresponding scores. This is achieved by using an additional input based on an aggregated score-weighted heatmap 20 representation of all available ROIs. An overall scoring module can be realized using an available classifier architecture such as the Densenet 24 and modifying the initial convolution layer 22.1, 22.2 to focus the network attention based on the aggregated, score-weighted heatmap 20. The classifier architecture can be replaced with a regression model to increase the scoring sensitivity from a categorical to a continuous range.

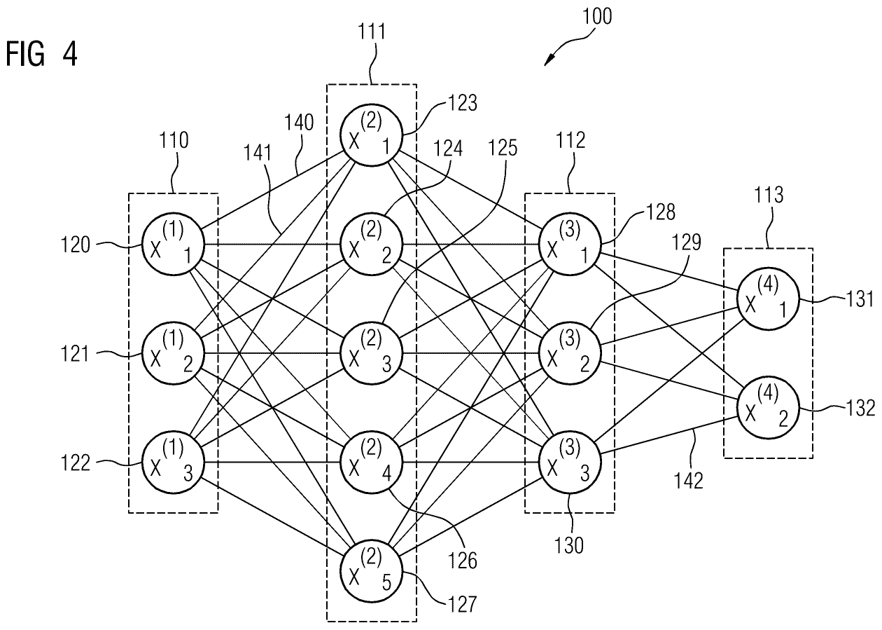

FIG. 4 displays an embodiment of an artificial neural network 100. Alternative terms for “artificial neural network” are “neural network”, “artificial neural net” or “neural net”.

The artificial neural network 100 comprises nodes 120, 132 and edges 140, . . . , 142, wherein each edge 140, . . . , 142 is a directed connection from a first node 120, . . . , 132 to a second node 120, . . . , 132. In general, the first node 120, . . . , 132 and the second node 120, . . . , 132 are different nodes 120, 132, it is also possible that the first node 120, . . . , 132 and the second node 120, . . . , 132 are identical. For example, in FIG. 1 the edge 140 is a directed connection from the node 120 to the node 123, and the edge 142 is a directed connection from the node 130 to the node 132. An edge 140, . . . , 142 from a first node 120, . . . , 132 to a second node 120, . . . , 132 is also denoted as “ingoing edge” for the second node 120, . . . , 132 and as “outgoing edge” for the first node 120, . . . , 132.

In this embodiment, the nodes 120, . . . , 132 of the artificial neural network 100 can be arranged in layers 110, . . . , 113, wherein the layers can comprise an intrinsic order introduced by the edges 140, . . . , 142 between the nodes 120, . . . , 132. In particular, edges 140, . . . , 142 can exist only between neighboring layers of nodes. In the displayed embodiment, there is an input layer 110 comprising only nodes 120, . . . , 122 without an incoming edge, an output layer 113 comprising only nodes 131, 132 without outgoing edges, and hidden layers 111, 112 in-between the input layer 110 and the output layer 113. In general, the number of hidden layers 111, 112 can be chosen arbitrarily. The number of nodes 120, . . . , 122 within the input layer 110 usually relates to the number of input values of the neural network, and the number of nodes 131, 132 within the output layer 113 usually relates to the number of output values of the neural network.

In particular, a (real) number can be assigned as a value to every node 120, . . . , 132 of the neural network 100. Here, x(n)i denotes the value of the i-th node 120, . . . , 132 of the n-th layer 110, . . . , 113. The values of the nodes 120, . . . , 122 of the input layer 110 are equivalent to the input values of the neural network 100, the values of the nodes 131, 132 of the output layer 113 are equivalent to the output value of the neural network 100. Furthermore, each edge 140, . . . , 142 can comprise a weight being a real number, in particular, the weight is a real number within the interval [−1, 1] or within the interval [0, 1]. Here, w(m,n)i,j denotes the weight of the edge between the i-th node 120, . . . , 132 of the m-th layer 110, . . . , 113 and the j-th node 120, . . . , 132 of the n-th layer 110, . . . , 113. Furthermore, the abbreviation w(n)i,j is defined for the weight w(n,n+1)i,j.

In particular, to calculate the output values of the neural network 100, the input values are propagated through the neural network. In particular, the values of the nodes 120, . . . , 132 of the (n+1)-th layer 110, . . . , 113 can be calculated based on the values of the nodes 120, . . . , 132 of the n-th layer 110, . . . , 113 by

xⱼ⁽ⁿ⁺¹⁾=f(Σᵢxᵢ⁽ⁿ⁾·w_{i,j}⁽ⁿ⁾).

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 110 are given by the input of the neural network 100, wherein values of the first hidden layer 111 can be calculated based on the values of the input layer 110 of the neural network, wherein values of the second hidden layer 112 can be calculated based in the values of the first hidden layer 111, etc.

In order to set the values w(m,n)i,j for the edges, the neural network 100 has to be trained using training data. In particular, training data comprises training input data and training output data (denoted as ti). For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

w′_{i,j}⁽ⁿ⁾=w_{i,j}⁽ⁿ⁾−γ·δⱼ⁽ⁿ⁾·xᵢ⁽ⁿ⁾

δⱼ⁽ⁿ⁾=(Σₖδₖ⁽ⁿ⁺¹⁾·w_{j,k}⁽ⁿ⁺¹⁾)·f′(Σᵢxᵢ⁽ⁿ⁾·w_{i,j}⁽ⁿ⁾)δⱼ⁽ⁿ⁾=(xₖ⁽ⁿ⁺¹⁾−tⱼ⁽ⁿ⁺¹⁾)·f′(Σᵢxᵢ⁽ⁿ⁾·w_{i,j}⁽ⁿ⁾)

wherein y is a learning rate, and the numbers δ(n)j can be recursively calculated as based on δ(n+1)j, if the (n+1)-th layer is not the output layer, and
if the (n+1)-th layer is the output layer 113, wherein f′ is the first derivative of the activation function, and y(n+1)j is the comparison training value for the j-th node of the output layer 113.

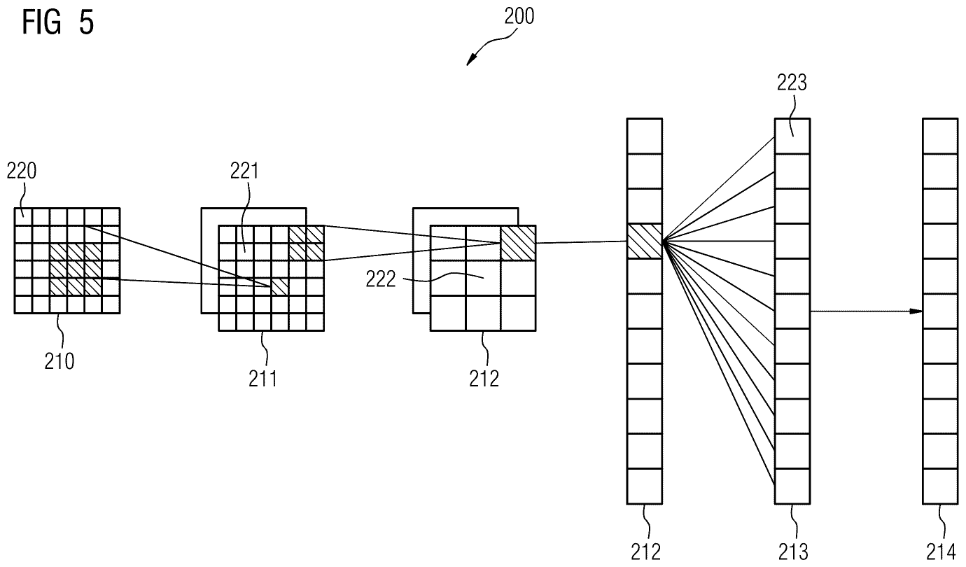

FIG. 5 displays an embodiment of a convolutional neural network 200. In the displayed embodiment, the convolutional neural network comprises 200 an input layer 210, a convolutional layer 211, a pooling layer 212, a fully connected layer 213 and an output layer 214. Alternatively, the convolutional neural network 200 can comprise several convolutional layers 211, several pooling layers 212 and several fully connected layers 213, as well as other types of layers. The order of the layers can be chosen arbitrarily, usually fully connected layers 213 are used as the last layers before the output layer 214.

In particular, within a convolutional neural network 200 the nodes 220, . . . , 224 of one layer 210, . . . , 214 can be considered to be arranged as a d-dimensional matrix or as a d-dimensional image. In particular, in the two-dimensional case the value of the node 220, . . . , 224 indexed with i and j in the n-th layer 210, . . . , 214 can be denoted as x(n) [i,j]. However, the arrangement of the nodes 220, . . . , 224 of one layer 210, . . . , 214 does not have an effect on the calculations executed within the convolutional neural network 200 as such, since these are given solely by the structure and the weights of the edges.

In particular, a convolutional layer 211 is characterized by the structure and the weights of the incoming edges forming a convolution operation based on a certain number of kernels. In particular, the structure and the weights of the incoming edges are chosen such that the values x(n)k of the nodes 221 of the convolutional layer 211 are calculated as a convolution x(n)k=Kk*x(n−1) based on the values x(n−1) of the nodes 220 of the preceding layer 210, where the convolution * is defined in the two-dimensional case as

xₖ⁽ⁿ⁾[i,j]=(Kₖ*x⁽ⁿ⁻¹⁾)[i,j]=Σ_{i′}Σ_{j′}Kₖ[i′,j′]·x⁽ⁿ⁻¹⁾[i−i′,j−j′].

Here the k-th kernel Kk is a d-dimensional matrix (in this embodiment a two-dimensional matrix), which is usually small compared to the number of nodes 220, . . . , 224 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 220, . . . , 224 in the respective layer 210, . . . , 214. In particular, for a convolutional layer 211 the number of nodes 221 in the convolutional layer is equivalent to the number of nodes 220 in the preceding layer 210 multiplied with the number of kernels.

If the nodes 220 of the preceding layer 210 are arranged as a d-dimensional matrix, using a plurality of kernels can be interpreted as adding a further dimension (denoted as “depth” dimension), so that the nodes 221 of the convolutional layer 221 are arranged as a (d+1)-dimensional matrix. If the nodes 220 of the preceding layer 210 are already arranged as a (d+1)-dimensional matrix comprising a depth dimension, using a plurality of kernels can be interpreted as expanding along the depth dimension, so that the nodes 221 of the convolutional layer 221 are arranged also as a (d+1)-dimensional matrix, wherein the size of the (d+1)-dimensional matrix with respect to the depth dimension is by a factor of the number of kernels larger than in the preceding layer 210.

The advantage of using convolutional layers 211 is that spatially local correlation of the input data can exploited by enforcing a local connectivity pattern between nodes of adjacent layers, in particular by each node being connected to only a small region of the nodes of the preceding layer.

In the displayed embodiment, the input layer 210 comprises 36 nodes 220, arranged as a two-dimensional 6×6 matrix. The convolutional layer 211 comprises 72 nodes 221, arranged as two two-dimensional 6×6 matrices, each of the two matrices being the result of a convolution of the values of the input layer with a kernel. Equivalently, the nodes 221 of the convolutional layer 211 can be interpreted as arranges as a three-dimensional 6×6×2 matrix, wherein the last dimension is the depth dimension.

A pooling layer 212 can be characterized by the structure and the weights of the incoming edges and the activation function of its nodes 222 forming a pooling operation based on a non-linear pooling function f. For example, in the two dimensional case the values x(n) of the nodes 222 of the pooling layer 212 can be calculated based on the values x(n−1) of the nodes 221 of the preceding layer 211 as

x⁽ⁿ⁾[i,j]=f(x⁽ⁿ⁻¹⁾[id₁,jd₂], . . . ,x⁽ⁿ⁻¹⁾[id₁+d₁−1,jd₂+d₂−1])

In other words, by using a pooling layer 212 the number of nodes 221, 222 can be reduced, by replacing a number d1·d2 of neighboring nodes 221 in the preceding layer 211 with a single node 222 being calculated as a function of the values of said number of neighboring nodes in the pooling layer. In particular, the pooling function f can be the max-function, the average or the L2-Norm. In particular, for a pooling layer 212 the weights of the incoming edges are fixed and are not modified by training.

The advantage of using a pooling layer 212 is that the number of nodes 221, 222 and the number of parameters is reduced. This leads to the amount of computation in the network being reduced and to a control of overfitting.

In the displayed embodiment, the pooling layer 212 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully-connected layer 213 can be characterized by the fact that a majority, in particular, all edges between nodes 222 of the previous layer 212 and the nodes 223 of the fully-connected layer 213 are present, and wherein the weight of each of the edges can be adjusted individually.

In this embodiment, the nodes 222 of the preceding layer 212 of the fully-connected layer 213 are displayed both as two-dimensional matrices, and additionally as non-related nodes (indicated as a line of nodes, wherein the number of nodes was reduced for a better presentability). In this embodiment, the number of nodes 223 in the fully connected layer 213 is equal to the number of nodes 222 in the preceding layer 212. Alternatively, the number of nodes 222, 223 can differ.

Furthermore, in this embodiment the values of the nodes 224 of the output layer 214 are determined by applying the Softmax function onto the values of the nodes 223 of the preceding layer 213. By applying the Softmax function, the sum of the values of all nodes 224 of the output layer is 1, and all values of all nodes 224 of the output layer are real numbers between 0 and 1. In particular, if using the convolutional neural network 200 for categorizing input data, the values of the output layer can be interpreted as the probability of the input data falling into one of the different categories.

A convolutional neural network 200 can also comprise a ReLU (acronym for “rectified linear units”) layer. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer. Examples for rectifying functions are f(x)=max(0,x), the tangent hyperbolics function or the sigmoid function.

In particular, convolutional neural networks 200 can be trained based on the backpropagation algorithm. For preventing overfitting, methods of regularization can be used, e.g. dropout of nodes 220, . . . , 224, stochastic pooling, use of artificial data, weight decay based on the L1 or the L2 norm, or max norm constraints.

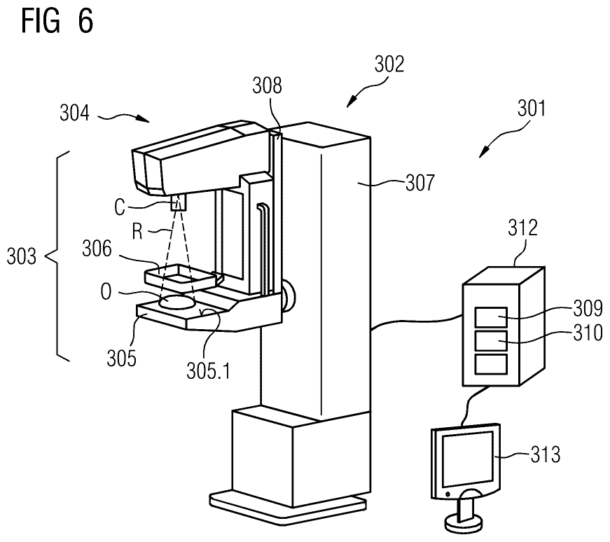

In FIG. 6, a mammography system 301, in particular in the form of a tomosynthesis system, is shown by way of example and roughly schematically. Relative directions such as “above”, “below”, etc. refer to a tomosynthesis system set up for operation as intended. The mammography system 301 includes a tomosynthesis device 302 and a control device 312. The tomosynthesis device 302 has a standing column 307 and a source-detector arrangement 303, which in turn comprise an X-ray source 304 and an X-ray detector 305 with a detector area 5.1. Standing column 307 is in operation on the ground. The source-detector arrangement 303 can be connected to it in a movable manner, so that the height of the detector surface 305.1, i.e. the distance to the substrate, can be adjusted to a chest height of a patient.

A breast O of the patient (shown schematically here) is the object of examination, the breast O, for an examination on the top of the detector surface 305.1. Above the chest O and the detector surface 305.1 a compression plate 306 is arranged, which is movably connected to the source-detector arrangement 303. For the examination, the breast O is compressed and at the same time fixed by lowering the compression plate 306 to it, so that pressure is applied on the breast O between compression plate 306 and detector surface 305.1.

The X-ray emitter 304 is arranged and designed opposite the X-ray detector 305 in such a way that the X-ray detector 305 detects X-rays R emitted by it after at least part of the X-ray radiation R has penetrated the patient's breast O. The X-ray emitter 304 is relative to the X-ray detector 305 via a rotary arm 308, for example, in a range of ±25° around a basic position, in which it is perpendicular to the detector surface 305.1.

The mammography system 301 can in particular a control device 12 and a computer unit with a scoring system 309 and a training unit 310. The control device 312 is connected to a terminal 313, for example having a user interface or display unit, through which a user can communicate commands to the tomosynthesis system 301 or retrieve measurement results, for example the X-ray. The control device 312 may be located in the same room as the tomosynthesis device 302, but it may also be located in an adjacent control room or at an even greater spatial distance.

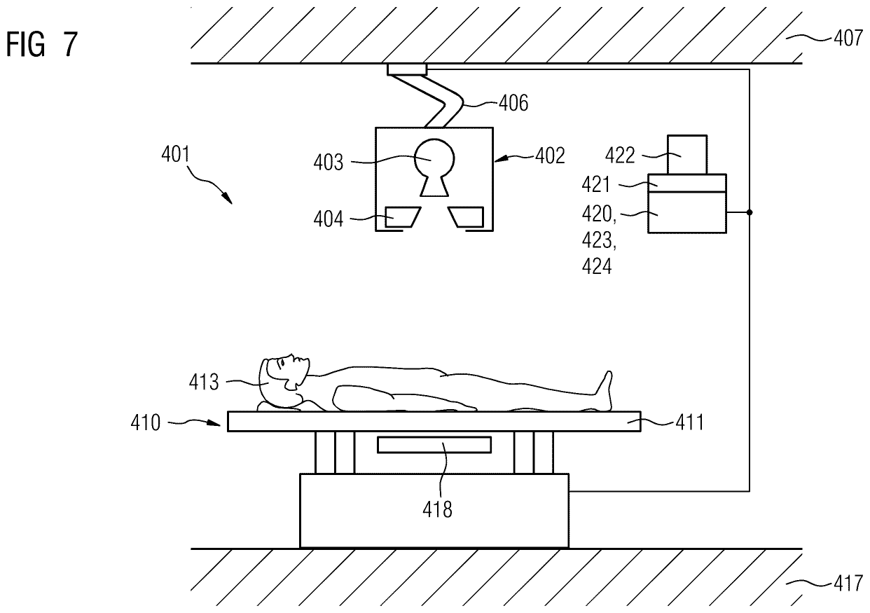

FIG. 7 shows an exemplary embodiment of an X-ray system 401, especially a radiography system, according to the invention. The X-ray system 401 has a patient positioning device 410 with a table 411 fixed to the floor 417. The object 413 lies on the table 411. The patient positioning device 410 further comprises an X-ray detector unit 418.

The X-ray system 401 comprises an X-ray source 403 and an X-ray detector unit 418. The X-ray source unit 402, which comprises the X-ray source 403 and a collimator unit 404. The X-ray source unit 402 can be connected to the ceiling 407 of the examination room via a ceiling mount 406. Via the ceiling mount 406, the X-ray source 403 can be moved.

The X-ray system 401 may also comprise an input unit 421 and an output unit 422. The input unit 421 and the output unit 422 may be connected to the control unit 420. The control unit 420 comprises the scoring system 423. The control unit 420 may further comprise or be connected to the training unit 424.

Although the present invention has been disclosed in the form of preferred embodiments and variations thereon, it will be understood that numerous additional modifications and variations could be made thereto without departing from the scope of the invention. For the sake of clarity, it is to be understood that the use of “a” or “an” throughout this application does not exclude a plurality, and “comprising” does not exclude other steps or elements. The expression “a number of” means “at least one”. The mention of a “unit” or a “device” does not preclude the use of more than one unit or device. The expression “a number of” has to be understood as “at least one”.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the invention has been further illustrated in detail by the preferred embodiments, the invention is not limited by the disclosed examples and other variations may be derived therefrom by those skilled in the art without departing from the scope of protection of the invention.

1. A computer-implemented method for providing a positioning score regarding a positioning of an examining region in an X-ray image, comprising:
receiving input data, the input data comprising an X-ray image including the examining region;
applying a first trained function to the input data to detect at least one region of interest in the X-ray image and to generate a heatmap comprising the at least one region of interest;
applying a second trained function to the input data and the heatmap to generate an individual score for each of the at least one region of interest and to generate a score-weighted heatmap based on the at least one region of interest and the individual scores;
applying a third trained function to the input data and the score-weighted heatmap to generate a positioning score; and
providing the positioning score.

2. The method of claim 1, wherein the X-ray image is a two-dimensional X-ray image.

3. The method of claim 1, wherein the first trained function is based on an object detection network.

4. The method of claim 1, wherein at least one of the second trained function or the third trained function is based on a classifier or a regression model.

5. The method of claim 4, further comprising:
modifying an initial convolution layer to focus network attention based on at least one of the heatmap or the score-weighted heatmap.

6. The method of claim 1, further comprising:
displaying at least one of the heatmap or the at least one region of interest.

7. The method of claim 1, wherein at least one of the heatmap or the at least one region of interest is adjustable.

8. The method of claim 1, wherein the positioning score describes a rotation of the examining region.

9. The method of claim 1, wherein the examining region comprises a knee, a thorax, or a breast.

10. A scoring system, comprising:
a first interface configured to receive input data, the input data comprising an X-ray image including the examining region;
a first computation unit configured to apply a first trained function to the first input data to generate first output data, to detect at least one region of interest in the X-ray image and to generate a heatmap comprising the at least one region of interest;
a second computation unit configured to apply a second trained function to the input data and the heatmap to generate an individual score for each of the at least one region of interest and to generate a score-weighted heatmap based on the at least one region of interest and the individual scores;
a third computation unit configured to apply a third trained function to the input data and the score-weighted heatmap and to generate a positioning score; and
a second interface configured to provide the positioning score.

11. A non-transitory computer program product comprising instructions which, when executed by a scoring system, cause the scoring system to perform the method of claim 1.

12. A non-transitory computer-readable medium comprising instructions which, when executed by a scoring system, cause the scoring system to perform the method of claim 1.

13. An X-ray system comprising the scoring system of claim 10.

14. The X-ray system of claim 13, wherein the X-ray system is a radiography system or a mammography system.

15. The method of claim 2, wherein the first trained function is based on an object detection network.

16. The method of claim 15, wherein at least one of the second trained function or the third trained function is based on a classifier or a regression model.

17. The method of claim 16, further comprising:
modifying an initial convolution layer to focus network attention based on at least one of the heatmap or the score-weighted heatmap.

18. The method of claim 17, further comprising:
displaying at least one of the heatmap or the at least one region of interest.

19. The method of claim 18, wherein at least one of the heatmap or the at least one region of interest is adjustable.

20. The method of claim 19, wherein the positioning score describes a rotation of the examining region.
